(19) United States
(12) Patent Application Publication
(10) Pub. No.: US 2018/0149743 A1
(43) Pub. Date: May 31, 2018

(54) SOFT DETECTION OF SAFETY ZONE USING AUTOMOTIVE RADAR

(71) Applicant: GM GLOBAL TECHNOLOGY OPERATIONS LLC, Detroit, MI (US)

(72) Inventors: Oded Bialer, Petah Tivak (IL); Igal Bilik, Rehovot (IL); Gil Golan, Bnei Zion (IL)

(21) Appl. No.: 15/365,285

(22) Filed: Nov. 30, 2016

(51) Int. Cl. G01S 13/93; B62D 6/00

(52) U.S. Cl. CPC G01S 13/931; B62D 6/001

(57) ABSTRACT

A system and method for navigating a vehicle with respect to an object is disclosed. The system includes a transmitter for transmitting a source signal, a receiver for receiving an echo signal that is a reflection of the source signal from the object, and a processor. A parameter of the object is obtained at a radar system and an avoidance criterion is selected for the object. The processor determines a boundary of the object for the parameter of the object and the selected avoidance criterion and the vehicle is navigated in order to avoid the object based on the determined boundary.

### FIELD OF THE INVENTION

The subject invention relates to navigation system in vehicles and, in particular, to a method of determining a boundary of an object based on radar signals in order to ensure navigation with respect to the object.

### BACKGROUND

Recent automobiles and vehicles have been built with on-board safety systems which include radar technologies for detecting a location of an object with respect to the vehicle so that a driver or a collision-avoidance device of the vehicle can react accordingly. A radar system includes a transmitter for sending out a source signal and a receiver for receiving an echo or reflection of the source signal from the object. The received signal is sampled at a selected sampling frequency and the sampled data points of the received signal are entered into a Fast Fourier Transform (FFT) in order to determine a frequency of the returning signal. A parameter of the object such as a range, a relative velocity of the object with respect to the vehicle or other parameter can be determined from this frequency.

The parameter of the object is generally represented at the radar system as a point at a single location in a data space. However, it is known that objects generally extend into space and are not limited to a single point in space. Knowing the spatial extent of the object allows one to drive one's vehicle around the detected object successfully and without incident. Accordingly, it is desirable to provide a radar system and method that identifies a size and shape of a detected object within a reasonable probability in order to successfully navigate around the detected object.

### SUMMARY OF THE INVENTION

In one exemplary embodiment of the invention, a method of navigating a vehicle with respect to an object is disclosed. A parameter of the object is obtained at a radar system. An avoidance criterion is selected for the object and a boundary of the object is determined for the parameter of the object and the selected avoidance criterion. The vehicle is navigated in order to avoid the object based on the determined boundary.

In another exemplary embodiment of the invention, a system for navigating a vehicle with respect to an object is disclosed. The system includes a transmitter for transmitting a source signal, a receiver for receiving an echo signal that is a reflection of the source signal from the object, and a processor that runs a program. The program run at the processor determines a parameter of the object at a radar system, selects an avoidance criterion for the object, determines a boundary of the object for the parameter of the object and the selected avoidance criterion, and navigates the vehicle in order to avoid the object based on the determined boundary.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 shows a vehicle that includes a radar system suitable for determining a range and/or a relative velocity of an object with respect to the vehicle;

FIG. 2 shows representations of various objects that may be detected using the radar system of FIG. 1; and

FIG. 3 shows a flowchart illustrating a method of navigating a vehicle with respect to an object using the methods disclosed herein.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features

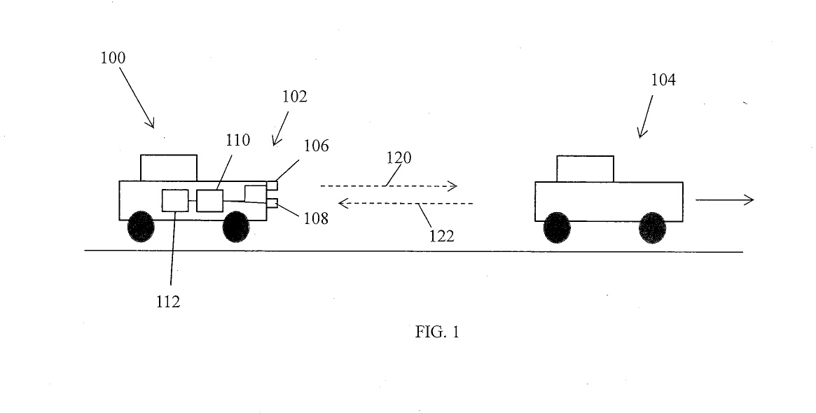

In accordance with an exemplary embodiment of the invention, FIG. 1 shows a vehicle 100, such as an automobile, that includes a radar system 102 suitable for determining a distance and/or a relative velocity of an object 104 with respect to the vehicle 100. In the embodiment shown in FIG. 1, the radar system 102 includes a transmitter 106 and a receiver 108. In alternate embodiments, the radar system 102 may be a MIMO (multi-input, multi-output) radar system that includes an array of transmitters and an array of receivers. A control unit 110 on-board the vehicle 100 controls and operates the transmitter 106 to generate a radio frequency wave (a “source signal” 120). In an embodiment, the source signal 120 includes a linear frequency-modulated continuous wave (LFM-CW), often referred to as a chirp signal. Alternately, the source signal 120 can be a pulsed signal or a combination of pulsed and chirp signals. A reflection of the source signal 120 from the object 104 is referred to herein as an echo signal 122. The echo signal 122 is received at the receiver 108, which generally includes circuitry for sampling the echo signal 122. The control unit 110 includes a processor that performs calculations on the echo signal 122 in order to determine distance and/or a relative velocity of the object 104 with respect to the vehicle 100 as well as a general shape of the object 104 according to methods disclosed herein. Knowledge of the distance, shape and/or relative velocity of the object 104 with respect to the vehicle 100 can then be used to maneuver the vehicle 100 by, for example, accelerating or decelerating the vehicle 100 or steering the vehicle in order to avoid the object 104. In an embodiment, the processor of the control unit 110 determines distance, velocity, shape, etc., of the object 104 and may cooperate with a collision-avoidance device 112 to control steering and acceleration/deceleration components to perform necessary maneuvers at the vehicle 100 to avoid the object 104. In another embodiment, the control unit 110 provides a signal to alert a driver of the vehicle 100 so that the driver can take any necessary action to avoid the object 104.

While the radar system 102 is discussed herein as being on-board vehicle 100, the radar system 102 may also be part of an immobile or stationary object in alternate embodiments. Similarly, the object 104 can be a vehicle or moving object or can be an immobile or stationary object.

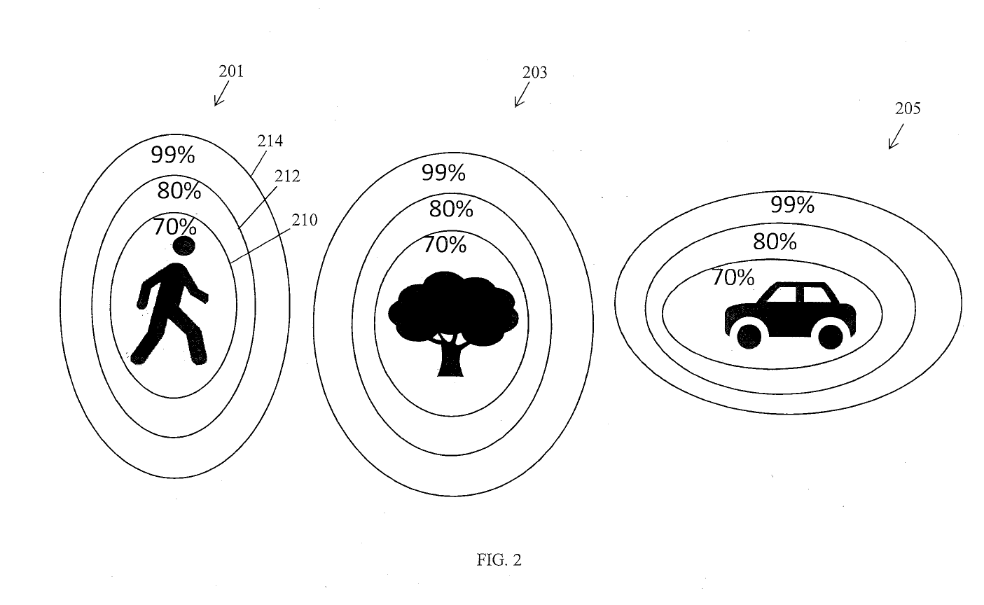

FIG. 2 shows representations of various objects (i.e., person 201, tree 203, and vehicular object 205) that may be detected using the radar system 102 of FIG. 1. In general, the processor of the radar system 110 receives the echo signal 122 reflected from the object and represents the object via a parameter calculated from the echo signal 122. The parameter may be for example, a range of the object, an elevation of the object, an azimuth of the object, or a velocity of the object. These parameters are generally represented by a single value or number vector, which represents the object as a single point in space. As is well known, the objects that are of concern to a driver are generally not single points but have a significant spatial extent.

In an embodiment, the processor performs a method of determining one or more boundaries for these objects (i.e., person 201, tree 203, and vehicular object 205). The determined boundary is a probabilistic boundary or, in other words, a boundary defined by a probability of the object existing at a selected location in space, wherein the object may be considered having a probability distribution in space. The size of the boundary depends on a criterion selected for the boundary. As can be seen in FIG. 2 for illustrative purposes, person 201 has an inner boundary 210, middle boundary 212 and outer boundary 214. Each of these boundaries is characterized by a probability. Inner boundary 210 is characterized by probability 70%; middle boundary 212 is characterized by probability 80% and outer boundary 214 is characterized by probability 99%. These probabilities indicate the probability that the person 201 is entirely contained within the selected boundary. Thus, there is a 70% chance that the person 201 is entirely contained within inner boundary 210, an 80% chance that the person 201 is entirely contained within middle boundary 212, and a 99% chance that the person 201 is entirely contained within outer boundary 214. Tree 203 and vehicular object 205 similarly have these boundaries.

The probability boundaries can alternatively be used to indicate the probability that vehicle 100 avoids contact with the object if the vehicle 100 stays outside of the selected boundary. Therefore, if the driver maintains the vehicle 100 outside of the outer boundary 214, there is a 99% probability of not colliding with the person 201. This probability drops at the middle boundary 212. If the driver is only able to keep the vehicle 100 outside of the middle boundary 212 (but not outside the outer boundary 214), there is an 80% probability of not colliding with the person 201. Finally if the driver is only able to keep the vehicle 100 outside of the inner boundary 210 (but not outside the middle boundary 212), there is only a 70% probability of not colliding with the person 201.

Once a boundary defining a probability of avoiding collision has been determined for a selected avoidance criterion, the vehicle 100 can navigate the surrounding environment based on the determined boundary.

The method of determining a probability distribution of the object is discussed herein. In an embodiment, the processor obtains signal Y from the object. In general Y can be a 4-dimensional vector in a 4-dimensional data space. Parameter p is detected by the radar system (i.e., range, elevation, azimuth, relative velocity) and determines a mean parameter \hat{p} of the object. An avoidance criterion δ is selected for navigating vehicle 100 with respect to the object. The avoidance criterion δ is related to probability of avoiding the object. When the avoidance criterion δ is low the probability of avoiding contact with object 104 is high. In an embodiment, an avoidance criterion may be δ=10⁻⁵.

An object parameter error is represented by ∥p−\hat{p}∥, whereas p is a variable representing a parameter of the object. The probability of the object being located at an offset or distance from the mean location is shown in Eq. (1):

Pr{∥p−\hat{p}∥<δ|Y}=∫_{∥p-\hat{p}∥<δ}f(p|Y)dp Eq. (1)

where f(p|Y) is a likelihood function or a conditional probability of the object having parameter p for a received 4-dimensional signal Y. The integral is performed over a region of parameter space defined by δ. The likelihood function can be rewritten using Bayes rule, as shown in Eq. (2):

f(p|Y)=f(Y|p)f(p)/f(Y) Eq. (2)

where f(p) is a distribution of the object and f(Y) is a distribution of the signal. The conditional probability f(Y|p) is a likelihood of receiving a signal Y for an object having parameter p. The object's distribution f(p) can be a uniform spatial distribution, but may also be a non-uniform spatial distribution in alternate embodiments. The conditional probability f(Y|p) can be represented as:

f(Y|p)≈αexp(B(p)*vec{Y}) Eq. (3)

where B(p) is a four-dimensional match filter (for range, elevation, azimuth and velocity) and vec{Y} is a vector representation of signal Y (a concatenation of columns of the signal Y). The probability distribution of the signal f(Y) can be restated by Eq. (4):

f(Y)=∫ₚ f(Y|p)f(p)dp Eq. (4)

Eqs. (1)-(4) can be combined to obtain Eq. (5) below:

$$Pr \{ ‖ p - \hat{p} ‖ < δ \vert Y \} = \frac{c}{{\int }_{{p}^{′}} exp ( B ( {p}^{′} ) * vec \{ Y \} ) {dp}^{′}} {\int }_{‖ p - \hat{p} ‖ < δ} exp ( B ( p ) * vec \{ Y \} ) dp \qquad ( Eq . ( 5 )$$

Thus, the probability of an object being at a selected location in space can be calculated for a given signal Y and a selected criterion δ.

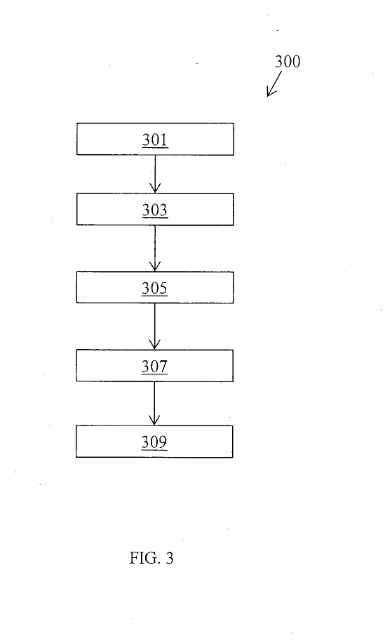

FIG. 3 shows a flowchart 300 illustrating a method of navigating a vehicle with respect to an object using the methods disclosed herein. In box 301, an echo signal is received at a radar system, wherein the echo signal is a reflection of a source signal of the radar system from the object. In box 303, a mean parameter of the object is determined from the source signal and echo signal. In box 305, an avoidance criterion is selected. In box 307, a parameter boundary is determined for the object given the mean parameter (from box 303) and the selected avoidance criterion (from box 305). Eq. (5) disclosed herein can be used to determine the boundary in box 307. In box 309, the boundary is provided to a navigation system or collision avoidance system that navigates the vehicle so as to avoid making contact with the object based on the determined boundary of the object.

In various embodiments, the vehicle 100 navigates around the object 104 by partitioning an environment that includes the object 104 into one or more safe zones defined by the determined boundary of the object 104. The processor then plans a path through the one or more safe zones of the environment.

The methods disclosed herein improve the ability of a radar system to distinguish an object by defining a boundary of the object 104 within a selected criterion. This boundary can be provided to the driver or to the collision avoidance system (112, FIG. 1) in order for the driver or the collision avoidance system 112 to navigate the environment to avoid the object 104, thus increasing a safety of the driver and vehicle.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method of navigating a vehicle with respect to an object, comprising:
obtaining a parameter of the object at a radar system;
selecting an avoidance criterion for the object;
determining a boundary of the object for the parameter of the object and the selected avoidance criterion; and
navigating the vehicle in order to avoid the object based on the determined boundary.

2. The method of claim 1, wherein determining the boundary further comprises determining a parameter error with respect to the obtained parameter for which a probability of the object existing is equal to the avoidance criterion.

3. The method of claim 1, further comprising determining the boundary for the object having a uniform spatial distribution.

4. The method of claim 1, further comprising partitioning an environment into safe zones defined by the boundary of the object.

5. The method of claim 4, further comprising planning a path through the safe zones of the environment.

6. The method of claim 1, wherein the radar system is conveyed by the vehicle.

7. The method of claim 1, further comprising providing the determined boundary to a collision-avoidance device and navigating the vehicle using the collision-avoidance device.

8. The method of claim 1, wherein the parameter is at least one of: (i) a range; (ii) an elevation; (iii) an azimuth; and (iv) a velocity.

9. The method of claim 1, further comprising selecting a value for the avoidance criterion for a selected level of avoidance.

10. A system for navigating a vehicle with respect to an object, comprising:
a transmitter for transmitting a source signal;
a receiver for receiving an echo signal that is a reflection of the source signal from the object;
running a program at a processor to:
determine a parameter of the object at a radar system;
select an avoidance criterion for the object;
determine a boundary of the object for the parameter of the object and the selected avoidance criterion; and
navigate the vehicle in order to avoid the object based on the determined boundary.

11. The system of claim 10, wherein the processor is further configured to determine the boundary by determining a parameter error with respect to the determined parameter for which a probability of the object existing is equal to the avoidance criterion.

12. The system of claim 10, wherein the processor is further configured to determine the probability for the object having a uniform spatial distribution.

13. The system of claim 10, wherein the processor is further configured to partition an environment into safe zones defined by the boundary of the object.

14. The system of claim 13, wherein the processor is further configured to plan a path through the safe zones of the environment.

15. The system of claim 10, wherein the transmitter, receiver and processor are conveyed by the vehicle.

16. The system of claim 10, further comprising a collision-avoidance device, wherein the processor provides the determined boundary to the collision-avoidance device and the collision-avoidance device navigates the vehicle using the determined boundary.

17. The system of claim 10, wherein the parameter is at least one of: (i) a range; (ii) an elevation; (iii) an azimuth; and (iv) a velocity.

18. The system of claim 10, wherein the avoidance criterion is a selectable value.
